(19) United States
(12) Patent Application Publication
(10) Pub. No.: US 2025/0278671 A1
(43) Pub. Date: Sep. 4, 2025

(54) ELECTROMAGNETIC, PHYSICAL GAME-SYSTEMS WITH INTEGRATED AI AND RFID TECHNOLOGY

(71) Applicant: BitForge Dynamics LLC, Monroe, LA (US)

(72) Inventors: Brock DAILY, Alma, AR (US); Daniel RUBINOV, Brooklyn, NY (US)

(21) Appl. No.: 19/049,724

(22) Filed: Feb. 10, 2025

Related U.S. Application Data
(60) Provisional application No. 63/551,307, filed on Feb. 8, 2024.

(51) Int. Cl. G06N 20/00; G06F 16/41; G06F 16/45; G06F 16/483

(52) U.S. Cl. CPC G06N 20/00; G06F 16/41; G06F 16/45; G06F 16/483

(57) ABSTRACT

A method for operating artificial intelligence (AI) models on a device without internet connectivity is disclosed. The method involves creating an embedded vector database local to the device, which contains contextual information for the AI models. This database is utilized to automatically generate and engineer prompt inputs for the AI models, facilitating their operation in an offline environment. The invention allows for the effective use of AI models in scenarios where internet connectivity is unavailable, providing robust and contextually appropriate AI functionality.

### RELATED APPLICATION

This application claims priority to U.S. Provisional Patent Application No. 63/551,307, filed on Feb. 8, 2024, the contents of which is incorporated herein in its entirety.

### FIELD OF THE INVENTION

The technical field of the invention resides at the intersection of AI, advanced data management, and user interface technology.

### SOME EXAMPLE EMBODIMENTS

The various embodiments described herein of the invention features an Offline Artificial Intelligence (AI) Engine capable of operating a wide range of AI models for tasks such as general information/web search (similar to most online search engines), system management, professional analyses, personal file management, and multi-modal content generation. This offline functionality ensures uninterrupted operation regardless of internet availability, enhancing data security and user privacy.

Central to the system's adaptability and learning capabilities is a Dataset Store integrated with an Embedded Vector Database. Users can upload or download diverse datasets, which are then compressed and efficiently stored locally to run anywhere, at any time the user wishes to use their AI. This database dynamically manages the data, using intelligent metadata processing to provide contextually relevant AI responses and continuous learning opportunities.

A key innovation of this system is the Advanced Prompt Engineering mechanism, which utilizes sophisticated algorithms for contextually interpreting user queries and generating accurate, personalized responses. This mechanism leverages the extensive data stored in the vector database, making the AI interactions highly relevant and informed.

Additionally, the Vector Database is uniquely designed to handle multi-modal data formats, including text, images, videos, audio, and various file types. This capability ensures a seamless and integrated AI experience, allowing the system to transition smoothly between different data types and applications.

### BRIEF DESCRIPTION OF THE DRAWINGS

The embodiments of the invention are illustrated by way of example, and not by way of limitation, in the figures of the accompanying drawings:

FIG. 1 is an architecture of an advanced virtual architecture application, detailing the interaction between the user, the local device, and the cloud-based repositories, according to one embodiment;

FIG. 2 is a diagram of process flow of the Advanced Virtual Assistant (A.V.A.) application, detailing the steps from application launch to task execution, according to one embodiment;

FIG. 3 is a diagram of a workflow of an advanced video processing system designed to enhance the analysis and comprehension of video content through a novel frame collaging technique and synchronized audio transcription, according to one embodiment;

FIG. 4 is a diagram of an example system for AVA, according to one embodiment;

FIG. 5 is diagram of an advanced cognitive architecture with GPT and ML vision systems for OS navigation, according to one embodiment;

FIG. 6 is a diagram of a backend and frontend architecture for AVA, according to one embodiment;

FIG. 7 is a diagram of hardware that can be used to implement an embodiment;

FIG. 8 is a diagram of a chip set that can be used to implement an embodiment; and

FIG. 9 is a diagram of a mobile terminal (e.g., handset or vehicle or part thereof) that can be used to implement an embodiment.

### DESCRIPTION OF SOME EXAMPLE EMBODIMENTS

A method and apparatus for advanced virtual architecture for local multi-modal artificial intelligence (AI) engine are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

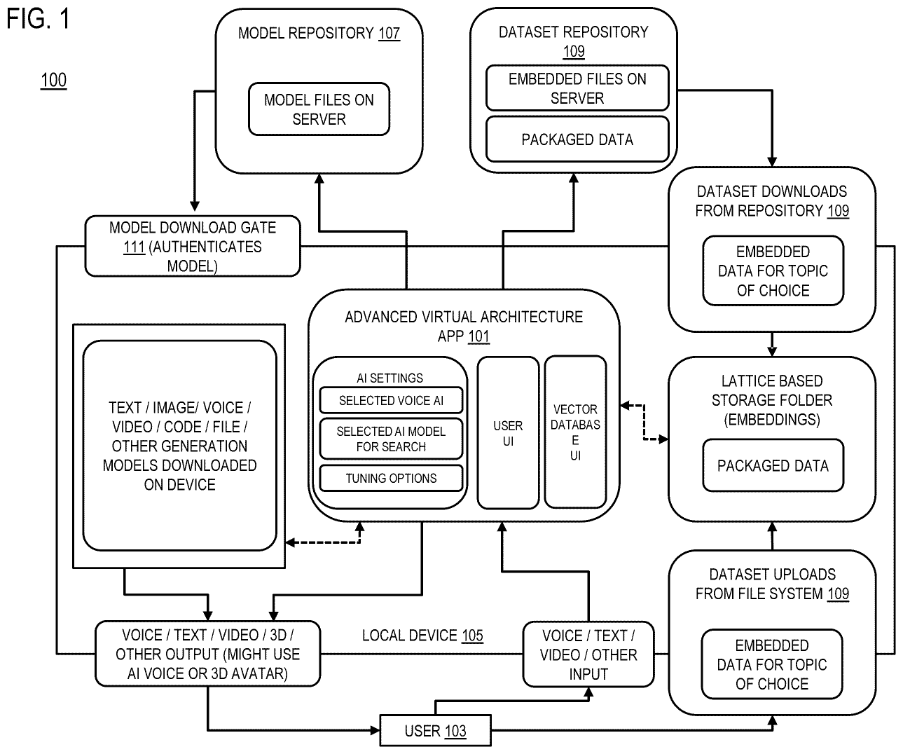

FIG. 1 is an architecture 100 of an advanced virtual architecture application 101, detailing the interaction between the user, the local device, and the cloud-based repositories, according to one embodiment. The various embodiments of the invention reside at the cutting-edge confluence of AI, advanced data management, and sophisticated user interface technology. It introduces an Advanced Virtual Architecture meticulously designed to empower AI models to execute a broad spectrum of tasks with unparalleled efficiency and versatility across diverse platforms and devices. In one embodiment, The invention's hallmark is its ability to function offline, dramatically reducing the dependency on cloud-based services and continuous internet connectivity, which is a significant departure from conventional AI systems.

At the core of this invention is the integration of multi-modal AI capabilities, an ambitious endeavor that brings together text, image, video, and audio processing in a cohesive and harmonious manner. This integration is not just superficial but deeply embedded into the architecture, enabling the AI to seamlessly switch between different modes of data processing and interpretation. The architecture's versatility allows it to be effectively implemented in a wide range of devices-from the most personal of handheld devices to the most complex and demanding professional systems.

In an era where data privacy and security are paramount, this invention stands out for its emphasis on local data processing. By enabling sophisticated AI operations to be conducted on the device itself, the invention significantly mitigates the risks associated with data transfer and storage in remote servers. This approach not only enhances data security but also ensures that the AI system is robust against internet connectivity issues, making it ideal for use in regions with unstable internet access. This feature is especially critical in sensitive environments, such as healthcare and finance, where data privacy is not just a preference but a stringent requirement.

The landscape of AI technology, as it stands today, is predominantly anchored in models that rely heavily on cloud computing and persistent internet connectivity. This reliance introduces a host of challenges that have become increasingly pronounced. Chief among these are concerns surrounding data privacy, as cloud-based systems often require the transfer of sensitive information to remote servers. Additionally, the operational costs associated with maintaining and accessing cloud-based AI models are substantial and often prohibitive, particularly for small-scale users and businesses.

Moreover, areas with limited or unreliable internet access face significant barriers in leveraging the power of AI, thereby creating a digital divide. In such contexts, AI technology remains an elusive tool, available only to those with consistent access to robust internet infrastructure. Furthermore, the predominant AI models are constrained by their specialized nature—typically focused on either text, image, video, or audio processing—and lack the ability to provide a multi-modal experience. This siloed approach to AI limits its applicability and flexibility, leaving vast potential unexplored.

In response to these challenges, the proposed invention endeavors to revolutionize the integration of AI into daily life and professional environments. By facilitating the operation of AI models on local devices efficiently, the invention circumvents the need for constant internet access and cloud dependency. This local operation approach not only addresses data privacy concerns but also significantly reduces operational costs and accessibility barriers.

The architecture of the proposed system is inherently designed to enhance the capabilities of AI models without necessitating their frequent retraining, a process that is typically resource-intensive and time-consuming.

### SUMMARY OF THE INVENTION

### 4.1 Offline AI Engine:

This engine is a sophisticated and multi-faceted core component that enables the operation of AI models across a wide spectrum of tasks, all without the need for internet connectivity.

Its capabilities are manifold:

Task Diversity: It is proficient in handling an array of tasks, from basic operating system functions to complex professional analyses, personal file management, and creative multi-modal content generation.

Task diversity for an AI engine refers to its ability to perform a wide range of tasks across different domains and applications. In other words, a diverse AI engine is capable of handling various types of tasks, such as natural language processing, computer vision, speech recognition, recommendation systems, autonomous driving, and more. This diversity enables the AI engine to address different challenges and meet the needs of various industries and use cases.

Having task diversity in an AI engine is essential for versatility and applicability. It allows the engine to be deployed in different scenarios, serving different purposes, without needing separate specialized models for each task. For example, a single AI engine with task diversity could power a virtual assistant for answering questions, analyze images for content moderation, and understand speech commands for controlling smart devices.

Achieving task diversity often requires a combination of different machine learning algorithms, architectures, and datasets tailored to specific tasks. It also involves continuous research and development efforts to expand the capabilities of the AI engine to cover new tasks and domains. Overall, task diversity enhances the utility and effectiveness of an AI engine, making it a more valuable and versatile tool for solving real-world problems across a wide spectrum of applications.

Operational Independence: The engine operates independently of cloud-based services, ensuring privacy and data security. This independence is critical in scenarios where internet connectivity is unreliable or non-existent.

Operational independence for an AI engine denotes its capacity to function autonomously without relying on cloud-based services, thus safeguarding privacy and data security. In scenarios where internet connectivity is unreliable or unavailable, this independence becomes paramount. By operating locally, the AI engine maintains control over sensitive data within the confines of the user's device or network, mitigating the risks associated with transmitting data to external servers.

This operational independence is achieved through various means, including on-device processing, locally stored models, and decentralized algorithms. On-device processing allows the AI engine to execute computations without relying on external servers, ensuring rapid response times and preserving functionality even in offline environments. Locally stored models contain the necessary algorithms and data within the device, eliminating the need for continuous internet access to retrieve information. Decentralized algorithms enable collaborative learning and decision-making among interconnected devices, facilitating distributed AI tasks without central coordination.

In addition to ensuring privacy and data security, operational independence offers other benefits such as enhanced reliability, reduced latency, and improved scalability. By reducing reliance on external services, the AI engine becomes more resilient to network failures and outages, ensuring uninterrupted operation in remote or constrained environments. Furthermore, the ability to operate independently enables the AI engine to scale efficiently across a multitude of devices, from smartphones to edge computing devices, without requiring significant infrastructure investments.

Overall, operational independence empowers AI engines to deliver intelligent capabilities while safeguarding privacy and data security, making them well-suited for applications where internet connectivity is unreliable or non-existent. This independence ensures that users can leverage the benefits of artificial intelligence without compromising their personal information or exposing sensitive data to external risks.

Platform Adaptability: Designed to be universally compatible, the engine can be deployed across various platforms and devices, adapting to their specific processing and operational capabilities. Any codebase that can run AI systems using the local device's graphics processing power will suffice for this part of the invention.

Platform adaptability for an AI engine underscores its capacity to seamlessly integrate and operate across diverse platforms and devices, accommodating their unique processing architectures and operational constraints. Engineered for universal compatibility, this AI engine transcends hardware disparities, ensuring its deployment and functionality across a spectrum of computing environments.

Key to its adaptability is the engine's ability to leverage the local device's graphics processing power, a resource commonly found in modern computing devices ranging from smartphones to powerful desktop computers. By harnessing this GPU capability, the AI engine optimizes its performance for tasks such as parallel processing, neural network computations, and image/video manipulation, thereby enhancing efficiency and accelerating inference times.

Furthermore, the engine is designed with flexibility in mind, allowing it to seamlessly integrate with various codebases and development frameworks that support AI systems. Whether utilizing TensorFlow, PyTorch, or other popular libraries, developers can easily leverage the engine's capabilities to deploy sophisticated AI applications across their preferred platforms without significant modifications or dependencies.

This platform adaptability extends beyond conventional computing devices to encompass edge computing and IoT (Internet of Things) devices, where computational resources may be limited. Through efficient resource utilization and optimization techniques, the AI engine ensures smooth operation even in resource-constrained environments, enabling intelligent functionalities in scenarios such as smart homes, industrial automation, and autonomous vehicles.

In summary, the platform adaptability of this AI engine empowers developers and users alike to leverage its capabilities across a wide range of platforms and devices. By harnessing local GPU resources and offering compatibility with diverse codebases, the engine facilitates the deployment of intelligent applications while maximizing performance and operational efficiency across various computing environments.

Enhanced User Experience: The offline functionality significantly enhances user experience, particularly in areas with limited internet access, making AI technology more accessible and inclusive.

Enhanced user experience for an AI engine is achieved through its offline functionality, which substantially improves accessibility and inclusivity, especially in regions with limited internet access. By eliminating the dependence on continuous online connectivity, the AI engine ensures that users can seamlessly access its intelligent features and capabilities regardless of their geographical location or internet availability.

In areas with limited internet access, traditional AI systems relying on cloud-based services may suffer from latency issues or complete inoperability. However, the offline functionality of this AI engine mitigates such challenges by enabling local execution of AI tasks directly on the user's device or network. This not only reduces latency but also enhances reliability and responsiveness, thereby providing a smoother and more consistent user experience.

Furthermore, the offline functionality enhances privacy and data security by keeping sensitive information within the user's control. Without the need to transmit data to external servers, users can trust that their personal data remains confidential and protected from potential security breaches or unauthorized access. This assurance fosters trust and confidence in the AI technology, further enhancing the overall user experience.

Moreover, the offline functionality promotes inclusivity by ensuring that AI technology is accessible to individuals in remote or underserved areas where internet infrastructure may be lacking or unreliable. Whether in rural communities, developing regions, or during travel in remote locations, users can still leverage the AI engine's capabilities without worrying about internet connectivity issues.

Overall, the enhanced user experience provided by the offline functionality of this AI engine not only improves accessibility and inclusivity but also enhances convenience, reliability, and privacy. By prioritizing offline capabilities, the AI engine empowers users to seamlessly integrate intelligent technologies into their daily lives, irrespective of their internet connectivity status, thereby democratizing access to AI and fostering greater adoption and acceptance of this transformative technology.

4.2 Dataset Store with Embedded Vector Database:

A central feature of this architecture is its dataset store, which is integrated with a state-of-the-art embedded vector database. The dataset store with an embedded vector database stands as a cornerstone within this architecture, boasting a blend of sophistication and innovation. At its core, this dual-component system is engineered to efficiently manage and manipulate vast datasets, offering a host of pioneering features. By integrating with state-of-the-art vector database technology, the dataset store achieves unparalleled efficiency in storage and retrieval, effortlessly handling both structured and unstructured data. Perhaps most notably, the system excels in its ability to seamlessly convert diverse data types into vector representations, enabling cross-modal comparisons and semantic similarity searches. This capability not only facilitates intuitive and contextually relevant search results but also empowers real-time analytics and insights generation directly from vectorized data. Furthermore, the architecture prioritizes scalability, adaptability, and robust security, ensuring seamless growth, flexibility, and protection of sensitive information. In essence, the dataset store with an embedded vector database represents a cutting-edge solution poised to revolutionize data management and analysis across a spectrum of applications and industries.

An embedded vector database refers to a specialized database system that is specifically designed to store, query, and analyze high-dimensional vector data efficiently. Unlike traditional relational databases that primarily handle structured data, embedded vector databases are optimized for managing unstructured or semi-structured data represented as vectors. These vectors typically encode complex information such as textual documents, images, audio clips, or other types of multimedia data.

One of the key features of an embedded vector database is its ability to perform similarity searches and nearest neighbor queries on vector data. This means that given a query vector, the database can efficiently retrieve the most similar vectors from the dataset based on some similarity measure, such as cosine similarity or Euclidean distance. This functionality is particularly useful in applications like recommendation systems, content-based search engines, and clustering algorithms.

Embedded vector databases often incorporate advanced indexing techniques and data structures tailored for high-dimensional data, enabling fast and scalable retrieval operations. Additionally, they may provide features for data preprocessing, dimensionality reduction, and real-time analytics to support various data-driven applications.

Overall, an embedded vector database serves as a powerful tool for managing and analyzing complex vector data, offering performance benefits and capabilities that are well-suited for modern data-intensive applications.

This dual-component system offers several innovative features:

User-Driven Data Enrichment: Users can upload or download diverse datasets, ranging from academic content to professional and personal data, which are then compressed and stored efficiently. One possible solution for delivery is an online marketplace, hosted for ‘cloud’ management of the datasets for Users to download or upload their own. (This could be a store for P2P transactions, allowing research teams to provide fact datasets for other user's to purchase).

In other words, an AI engine with an embedded vector database offers an innovative feature known as User-Driven Data Enrichment, revolutionizing how users interact with and contribute to datasets. This feature empowers users to upload or download diverse datasets encompassing academic content, professional data, and personal information, which are subsequently compressed and stored efficiently within the embedded vector database. To facilitate this process, a potential solution is the establishment of an online marketplace, acting as a centralized platform for the ‘cloud’ management of datasets. Within this marketplace, users can seamlessly upload their datasets for storage and enrichment, while also accessing a vast array of curated datasets contributed by other users. This marketplace could facilitate peer-to-peer transactions, allowing research teams or individuals to provide factual datasets for others to purchase, thereby fostering a collaborative ecosystem for data sharing and enrichment. Through this innovative feature, users are not only empowered to leverage a diverse range of datasets for their AI applications but also contribute to the collective knowledge pool, driving advancements in AI research and applications across various domains.

Dynamic Data Management: The embedded vector database manages this data dynamically, optimizing for quick retrieval, minimal storage footprint, and maintaining data integrity and security. Dynamic Data Management is a groundbreaking feature offered by an AI engine equipped with an embedded vector database, reshaping how data is handled within the system. This innovative capability harnesses the power of the embedded vector database to manage data dynamically, optimizing key aspects such as retrieval speed, storage efficiency, and data security. Leveraging advanced indexing techniques and efficient algorithms, the system ensures swift retrieval of data, minimizing latency and enhancing overall responsiveness. Moreover, through sophisticated compression methods and data representation techniques, the embedded vector database reduces the storage footprint while maintaining data integrity, enabling efficient resource utilization without sacrificing data richness. Additionally, robust mechanisms for data integrity and security, including encryption, access controls, and auditing protocols, are implemented to safeguard against unauthorized access and ensure compliance with regulatory standards. In essence, Dynamic Data Management empowers the AI engine to efficiently handle diverse datasets while prioritizing quick retrieval, minimal storage usage, and robust data security, thus laying the groundwork for scalable and reliable AI-driven applications across various domains.

For example, An embedded vector database facilitates quick retrieval, minimal storage footprint, and maintains data integrity and security through a combination of advanced techniques and optimizations:
1. Quick Retrieval: The database employs efficient indexing structures tailored for high-dimensional vector data. These indexing techniques allow for fast lookup and retrieval of data points based on similarity searches or other query criteria. By organizing data in a manner that facilitates rapid access, the database ensures quick retrieval times, minimizing latency and enhancing system responsiveness.
2. Minimal Storage Footprint: To minimize storage requirements, the database utilizes compact representations of data vectors. This can involve techniques such as dimensionality reduction, quantization, or sparse encoding, which reduce the number of bits needed to represent each vector while preserving essential information. Additionally, the database may employ compression algorithms to further reduce the storage footprint, optimizing resource utilization without compromising data richness or fidelity.
3. Data Integrity and Security: The database implements robust mechanisms to maintain data integrity and security. Encryption techniques are employed to protect data both at rest and in transit, ensuring confidentiality and preventing unauthorized access. Access controls and authentication mechanisms are enforced to restrict access to authorized users and prevent unauthorized modifications to the data. Moreover, the database may incorporate auditing and logging features to track data access and modifications, facilitating compliance with regulatory requirements and enabling forensic analysis in case of security incidents.

By integrating these features and optimizations, an embedded vector database provides for quick retrieval, minimal storage footprint, and maintains data integrity and security, making it well-suited for applications requiring efficient management of large volumes of high-dimensional vector data.

Intelligent Data Utilization: Metadata associated with each dataset is leveraged for intelligent prompt engineering, ensuring that AI responses are contextually relevant and informed by the latest available data. This will also help place embeddings from new datasets into the lattice-space for semantic clustering.

An embedded vector database facilitates Intelligent Data Utilization by leveraging metadata associated with each dataset to engineer intelligent prompts. This process ensures that AI responses are contextually relevant and informed by the latest available data. Metadata, which includes information such as timestamps, source identifiers, and categorical labels, provides valuable context about the datasets' contents and origins. By analyzing this metadata, the database can intelligently prompt the AI engine to generate responses tailored to specific contexts, user preferences, or temporal considerations.

Furthermore, leveraging metadata enables the embedding of new datasets into the lattice-space for semantic clustering. The lattice-space refers to the multi-dimensional vector space in which datasets are represented as vectors. By incorporating metadata-driven prompts and analyses, the database can map embeddings from new datasets into this space, facilitating semantic clustering based on similarities in content, context, or other relevant attributes. This clustering allows for the identification of related datasets and enables the AI engine to draw insights and make connections across diverse sources of data.

Overall, the embedded vector database's utilization of metadata for intelligent prompt engineering and semantic clustering enhances the AI engine's ability to generate contextually relevant responses and derive meaningful insights from disparate datasets. This integration of metadata-driven intelligence contributes to more effective data utilization, fostering improved decision-making, and enhancing the overall user experience.

Continuous Learning and Adaptation: The system continually integrates new data, refining and expanding the AI's knowledge base and capabilities over time. The lattice-space within the vector database will shift and grow node-clusters for related embeddings, these will provide a certain amount of ‘nearest-neighbors’ based on an embedding auto-query for the system during chats/searches.

An embedded vector database enables Continuous Learning and Adaptation by seamlessly integrating new data into the system, thereby refining and expanding the AI's knowledge base and capabilities over time. As new data is introduced, the vector database dynamically adjusts the lattice-space, a multi-dimensional vector space where datasets are represented as vectors. This adjustment involves the shifting and growth of node-clusters within the lattice-space to accommodate related embeddings.

The node-clusters serve as groupings of similar embeddings, facilitating semantic clustering based on similarities in content, context, or other relevant attributes. As the system receives new data, embeddings from these datasets are automatically compared to existing embeddings within the lattice-space. If similarities are detected, the new embeddings are integrated into the appropriate node-clusters, expanding the system's knowledge base and enabling it to provide contextually relevant responses based on the relationships between different datasets.

Moreover, the vector database supports an auto-query mechanism during chats or searches, enabling the system to identify and retrieve “nearest-neighbors” within the lattice-space. This process allows the AI to access related embeddings and provide relevant information or responses to user inquiries, leveraging the continuous learning and adaptation capabilities of the system.

In essence, the embedded vector database enables Continuous Learning and Adaptation by dynamically adjusting the lattice-space, incorporating new data, and facilitating semantic clustering and nearest-neighbor retrieval. This iterative process enhances the AI's knowledge base and capabilities over time, ensuring that it remains up-to-date and relevant in response to evolving user needs and data trends.

### 4.3 Advanced Prompt Engineering:

Advanced prompt engineering for an AI system represents a substantial advancement in the realm of AI-user interaction, distinguished by its depth and adaptability. This feature enhances the sophistication and effectiveness of interactions between users and the AI system, offering a more nuanced and personalized experience. At its core, advanced prompt engineering entails the crafting of prompts or queries that are carefully tailored to elicit specific responses or actions from the AI, taking into account various contextual factors, user preferences, and system capabilities.

One key aspect of advanced prompt engineering is the ability to construct prompts that are highly context-sensitive and adaptive. This involves analyzing contextual cues such as previous interactions, user demographics, and current environmental conditions to tailor prompts in real-time. By dynamically adjusting the language, tone, and content of prompts based on these contextual factors, the AI system can engage users more effectively and provide more relevant and meaningful responses.

Furthermore, advanced prompt engineering leverages sophisticated natural language understanding and generation techniques to craft prompts that are not only contextually relevant but also linguistically rich and nuanced. This may involve the use of advanced language models, semantic parsing algorithms, and sentiment analysis techniques to ensure that prompts are expressive, clear, and engaging.

Additionally, advanced prompt engineering encompasses the integration of user feedback and preferences into the prompt generation process. By incorporating feedback mechanisms and learning algorithms, the AI system can adapt and refine its prompts over time based on user interactions and preferences, enhancing the overall user experience and satisfaction.

This feature represents a significant advancement in the field of AI-user interaction, characterized by its depth and adaptability:

Contextual Understanding: Utilizing advanced algorithms, the system interprets user queries by considering their context, history, and the available data, resulting in highly relevant and personalized interactions.

Advanced prompt engineering signifies a notable leap forward in the domain of AI-user interaction, particularly concerning Contextual Understanding. By harnessing advanced algorithms, this approach enables the system to interpret user queries within the context of their conversation history, preferences, and the available data, leading to remarkably relevant and personalized interactions.

Traditionally, AI systems may struggle to grasp the nuanced context behind user queries, often resulting in generic or irrelevant responses. However, with advanced prompt engineering, the system gains the ability to analyze various contextual cues dynamically. This includes considering the user's past interactions with the system, their stated preferences, and even situational factors such as time of day or location. By integrating these contextual insights into the interpretation of user queries, the system can provide responses that are highly tailored to the specific needs and interests of the user.

Moreover, advanced prompt engineering allows the system to leverage available data sources to enrich its understanding of user queries. This could involve accessing relevant databases, analyzing external sources of information, or even tapping into real-time data streams. By incorporating this additional context, the system can offer more informed and accurate responses, further enhancing the quality of the user experience.

Semantic Embedding Searches: It conducts semantic embedding searches within the vector database to understand and respond to queries with nuanced accuracy.

Advanced prompt engineering stands as a pivotal advancement in the realm of AI-user interaction, particularly in the domain of Semantic Embedding Searches. This approach revolutionizes how the system conducts searches within the vector database, enabling a deeper understanding of user queries and delivering responses with nuanced accuracy.

Traditionally, AI systems may struggle to comprehend the nuanced meaning behind user queries, leading to inaccuracies or irrelevant responses. However, with advanced prompt engineering, the system leverages semantic embedding searches within the vector database. This technique involves representing both user queries and database entries as high-dimensional vectors, where the closeness of vectors indicates semantic similarity.

By employing semantic embedding searches, the system gains the ability to understand the underlying meaning and context of user queries in a more nuanced manner. It can identify subtle nuances, synonyms, and contextual variations within the queries, allowing for a more accurate interpretation of user intent.

Furthermore, semantic embedding searches enable the system to provide responses with nuanced accuracy. By retrieving database entries that closely match the semantics of the user query, the system can deliver highly relevant and contextually appropriate responses. This ensures that users receive information or assistance that aligns closely with their needs and preferences, enhancing the overall user experience.

Dynamic Response Generation: The AI can generate responses that are not only accurate but also rich in content, drawing from the extensive database and real-time user inputs.

Advanced prompt engineering signifies a substantial advancement in the domain of AI-user interaction, particularly concerning Dynamic Response Generation. This approach transforms how the AI generates responses, ensuring they are not only accurate but also rich in content by drawing from an extensive database and real-time user inputs.

Traditionally, AI systems may struggle to produce responses that are both accurate and contextually relevant, often resulting in generic or incomplete answers. However, with advanced prompt engineering, the AI can dynamically generate responses that are tailored to the specific query while also being enriched by insights gleaned from the extensive database and real-time user inputs.

By harnessing advanced algorithms and natural language processing techniques, the AI system can analyze user queries and contextual cues to generate responses that are highly relevant and informative. Additionally, it can draw from the vast repository of data stored in the database, accessing a wealth of information to enrich its responses with additional context, examples, and insights.

Moreover, the AI system can incorporate real-time user inputs into its response generation process, adapting its answers based on the evolving conversation dynamics. By continuously monitoring user interactions and feedback, the system can iteratively refine its responses, ensuring they remain accurate, engaging, and contextually appropriate.

### 4.4 Multi-Modal Vector Database Utilization:

An advanced AI engine with a local embedded vector database enhances its versatility through Multi-Modal Vector Database Utilization, a capability that enables the system to effectively leverage diverse types of data representations stored within the vector database. This approach enables the AI engine to seamlessly integrate and analyze data from multiple modalities, such as text, images, audio, and video, thereby enriching its understanding and capabilities across various domains.

Firstly, the embedded vector database allows for the storage and retrieval of multi-modal data representations. By representing data from different modalities as vectors within the database, the AI engine gains the ability to access and analyze information from disparate sources in a unified manner. This facilitates holistic understanding and processing of complex data sets containing diverse types of information.

Secondly, Multi-Modal Vector Database Utilization enables the AI engine to perform cross-modal retrieval and analysis. This means that the system can identify and retrieve related information across different modalities based on semantic similarities or contextual relevance. For example, the system could correlate textual descriptions with corresponding images or audio recordings, facilitating more comprehensive analysis and interpretation of multimedia content.

Moreover, Multi-Modal Vector Database Utilization enables the AI engine to integrate insights from multiple modalities to enhance its decision-making and inference capabilities. By combining information from text, images, audio, and other sources, the system can generate more accurate and contextually relevant responses, recommendations, or predictions. This versatility allows the AI engine to adapt to a wide range of tasks and applications, from natural language understanding and image recognition to multimedia content analysis and beyond.

This invention's vector database is uniquely equipped to handle and process multi-modal data, enhancing the AI's versatility:

Format-Agnostic Data Handling: Capable of managing text, images, videos, audio, code, and other file types, the database is a hub for diverse data types, essential for a multi-modal AI system.

An advanced AI engine with a local embedded vector database facilitates Multi-Modal Vector Database Utilization through Format-Agnostic Data Handling, a capability that enables the database to effectively manage a wide range of data types without being restricted by their specific formats. This feature serves as a cornerstone for a multi-modal AI system, allowing the engine to seamlessly integrate and analyze diverse data modalities, including text, images, videos, audio, code, and other file types.

Firstly, the embedded vector database is designed to accommodate diverse data representations by storing them as high-dimensional vectors. This format-agnostic approach ensures that data from different modalities can be uniformly represented within the database, enabling consistent and efficient handling regardless of the original format. Whether it's text documents, image pixels, audio waveforms, or video frames, the database can store and process them all as vectors, thereby facilitating seamless integration and analysis.

Secondly, format-agnostic data handling enables the database to serve as a central hub for diverse data types, essential for supporting a multi-modal AI system. By storing data from various modalities within the same database, the system fosters interoperability and cross-modal analysis, allowing insights to be derived from the relationships between different types of data. For example, the system could correlate textual descriptions with corresponding images or audio recordings, facilitating more comprehensive understanding and analysis of multimedia content.

Moreover, format-agnostic data handling enables the AI engine to perform cross-modal retrieval and analysis, where information from different modalities can be seamlessly integrated and analyzed together. This allows the system to leverage insights from one modality to enhance understanding and analysis in another modality, thereby enriching the AI's capabilities and improving the quality of its responses, recommendations, or predictions.

Metadata-Driven Retrieval: Advanced metadata processing capabilities ensure data is not just stored but understood in context, enabling more accurate and relevant AI interactions.

An advanced AI engine with a local embedded vector database facilitates Multi-Modal Vector Database Utilization through Metadata-Driven Retrieval, a capability that enhances the system's ability to understand and utilize data in context. This approach leverages advanced metadata processing capabilities to ensure that data is not only stored but also comprehensively understood, enabling more accurate and relevant AI interactions across diverse modalities.

Firstly, the embedded vector database incorporates sophisticated metadata processing techniques to capture and analyze contextual information associated with each data entry. This metadata may include details such as timestamps, source identifiers, content categories, or user tags, providing valuable context about the origin, content, and relevance of the data. By processing and understanding this metadata, the AI engine gains deeper insights into the context surrounding each data entry, enabling more informed retrieval and analysis.

Secondly, Metadata-Driven Retrieval enables the AI engine to perform more accurate and contextually relevant searches within the vector database. By leveraging the metadata associated with each data entry, the system can tailor retrieval queries to consider factors such as relevance, recency, or user preferences. This ensures that retrieved data aligns closely with the specific requirements and context of the AI interactions, enhancing the accuracy and effectiveness of the system's responses.

Moreover, Metadata-Driven Retrieval facilitates cross-modal analysis and integration by providing additional context for data interpretation. By considering metadata alongside the data itself, the AI engine can correlate information from different modalities, identify relevant patterns or relationships, and derive deeper insights from the data. This enables the system to generate more comprehensive and contextually informed responses, recommendations, or predictions, thereby enhancing the overall quality of AI interactions.

Integrated Multi-Modal Experience: This multi-modal capability allows the AI to integrate and transition seamlessly between different data types, offering a cohesive and immersive user experience.

An advanced AI engine with a local embedded vector database enables Multi-Modal Vector Database Utilization through Integrated Multi-Modal Experience, a capability that empowers the AI to seamlessly integrate and transition between different data types, providing users with a cohesive and immersive experience.

Firstly, the embedded vector database serves as a central repository for storing and managing data from various modalities, including text, images, videos, audio, and more. This multi-modal data storage enables the AI engine to access and analyze diverse types of information within a unified framework, facilitating seamless integration and interaction across different data types.

Secondly, the AI engine is equipped with advanced algorithms and processing capabilities that allow it to interpret and analyze data from different modalities comprehensively. Whether it's understanding textual queries, analyzing visual content, or processing audio inputs, the AI engine can leverage its multi-modal capabilities to extract meaningful insights and provide relevant responses or actions.

Moreover, the integrated multi-modal experience enables the AI engine to transition seamlessly between different data types based on user interactions or contextual cues. For example, during a conversation, the AI may start by processing text inputs from the user, but seamlessly switch to analyzing images or videos as the conversation evolves. This fluid transition between modalities enhances the user experience by providing a more natural and intuitive interaction with the AI.

### 4.5 Innovative Video Processing Technique:

An advanced AI engine with a local embedded vector database offers innovative video processing capabilities by leveraging its inherent versatility, efficiency, and adaptability. One of the key features that enable this innovation is the ability to bypass the need for specialized training and models, thereby streamlining the video processing pipeline and making it more accessible to a wider range of applications.

Firstly, the embedded vector database facilitates efficient storage and retrieval of video data without requiring specialized models or preprocessing steps. Video frames can be represented as high-dimensional vectors and stored within the database, enabling rapid access and retrieval during processing. This eliminates the need for separate training of models for tasks such as object detection, classification, or scene segmentation, as the AI engine can directly analyze the video data within the vector database.

Secondly, the AI engine leverages its general-purpose computational capabilities to perform video processing tasks in a highly efficient manner. By utilizing optimized algorithms and parallel processing techniques, the engine can analyze video frames in real-time or near-real-time, even on resource-constrained devices such as smartphones or edge computing devices. This ensures that video processing tasks can be performed locally without relying on cloud-based services or specialized hardware.

Moreover, the embedded vector database enables semantic understanding and contextual analysis of video content through advanced techniques such as semantic embedding and similarity search. This allows the AI engine to identify relevant patterns, objects, or events within the video data, without requiring extensive training on specific datasets or domains. Additionally, the database can facilitate content-based retrieval and recommendation of videos based on similarity to user preferences or search queries, enhancing user engagement and satisfaction.

A novel approach to video processing is introduced, bypassing the need for specialized training and models:

Frame Collaging and Multi-Threading: The technique utilizes frame collaging and multi-threading to analyze video content, enhancing efficiency and depth of analysis.

One example process is as follows:
1. Sequential Frame Extraction: The video is processed sequentially, with frames extracted in the order they appear in the video. Each frame is captured at regular intervals or as dictated by the video's frame rate, ensuring a continuous stream of frames.
2. Frame Compositing: Once a sufficient number of frames are extracted, they are composited together over a defined number of frames or a specific duration of time. This compositing process involves blending or overlaying the frames to create a single, continuous collage representing a segment of the video.
3. Collage Generation: The resulting collage, comprising a sequence of frames, is generated as a new video sequence or image file. This collage encapsulates a condensed representation of the original video segment, comprising consecutive frames captured in sequence.
4. Input to AI Engine: The generated collage is input to the AI engine for processing. This input comprises the sequential frames composing the collage, providing a continuous visual stream for analysis and interpretation.
5. AI Processing: The AI engine processes the input collage, analyzing the sequential frames to extract insights, identify patterns, or perform other relevant tasks. This may involve tasks such as semantic analysis, object recognition, scene understanding, or any other AI-driven analysis based on the specific objectives of the processing task.
6. Output Generation: Finally, the output of the AI processing is generated, which may include insights, visualizations, or other outputs based on the analysis of the input collage. These outputs can be used for various purposes such as storytelling, data visualization, creative expression, or decision-making support.

In a multi-threaded implementation of frame collaging for AI processing, the video is initially segmented into smaller sections, with each segment containing a predefined number of frames. These segments are then allocated to individual threads, allowing for parallel processing. Each thread is tasked with extracting frames from its designated segment and composing them into a collage. Concurrently, the collages are passed to a pool of AI processing threads responsible for analyzing them. Each AI processing thread independently performs tasks such as semantic analysis, object recognition, or scene understanding on the collages. As the AI processing threads complete their tasks, synchronization mechanisms ensure the orderly aggregation of results. Finally, the outputs, including insights, visualizations, or other processed data, are generated based on the collective analysis results. This multi-threaded approach enhances efficiency by enabling concurrent processing of multiple video segments and collages, ultimately facilitating faster analysis and more responsive interactions.

Comprehensive Content Interpretation: By synchronizing video frame analysis with audio transcriptions, the system achieves a holistic understanding of video content, interpreting both visual and auditory data in tandem.

The process of Comprehensive Content Interpretation through AI engine processing of video involves synchronizing video frame analysis with audio transcriptions to achieve a holistic understanding of the content. Initially, the AI engine analyzes individual frames of the video to extract visual information, employing computer vision techniques to identify objects, detect motion, and recognize faces within each frame. Simultaneously, the audio track of the video undergoes transcription using speech recognition algorithms, converting spoken words and sounds into written text. The timestamps of each frame are then synchronized with corresponding timestamps in the audio transcription to align visual and auditory data. Through this synchronization, the AI engine integrates visual insights with textual content, enabling a comprehensive interpretation of both visual and auditory cues. Further semantic analysis is conducted to extract higher-level meaning from the synchronized data, including identifying keywords, sentiments, and topics within the audio transcriptions. This integrated approach enhances the system's capability for tasks such as video summarization, content recommendation, sentiment analysis, and automatic captioning, facilitating more effective and contextually relevant applications of multimedia content analysis.

Flexibility in Application: The method is adaptable for both pre-recorded and real-time video content, broadening its applicability in various fields like security, communication, and content creation.

AI engine processing of video exhibits Flexibility in Application, as it is adaptable for both pre-recorded and real-time video content, thereby expanding its applicability across diverse fields such as security, communication, and content creation. This flexibility allows the method to cater to various use cases and scenarios, offering versatility and scalability in its deployment.

In the context of pre-recorded video content, the AI engine can analyze existing video archives or datasets, enabling retrospective analysis, content categorization, and trend identification. This capability is particularly valuable in security applications, where historical footage can be scrutinized for anomaly detection, event reconstruction, or forensic investigation. Additionally, in content creation, the AI engine can assist in video editing, post-production tasks, and automatic tagging or labeling of multimedia assets, streamlining workflows and enhancing productivity.

Moreover, the method's adaptability for real-time video content extends its utility to applications requiring immediate response and decision-making. In security and surveillance systems, the AI engine can process live video feeds for real-time threat detection, object tracking, or personnel monitoring. Similarly, in communication platforms or live streaming services, the AI engine can analyze video content on-the-fly, enabling features such as automatic captioning, content moderation, or audience engagement analytics.

The method's flexibility in application is underpinned by its ability to seamlessly transition between pre-recorded and real-time video processing modes, accommodating the diverse needs and requirements of different domains. This adaptability broadens its applicability across various fields, including security, communication, and content creation, where the timely analysis and interpretation of video content are paramount. Ultimately, this flexibility enhances the method's value proposition, making it a versatile solution for addressing a wide range of challenges and opportunities in today's digital landscape.

### Detailed Breakdown of the Invention:

### Extensive Expansion of Auto-Query System

The Auto-Query System is a sophisticated and intricately designed component of the invention, representing a quantum leap in AI interaction. It redefines the paradigm of AI responsiveness by introducing a multifaceted and deeply intelligent approach to understanding and responding to user queries.

An auto-query system for an AI engine is a mechanism designed to automatically generate and submit queries to the AI engine based on certain criteria or triggers, without the need for direct user input. This system enables the AI engine to continuously gather relevant information, perform analyses, and provide insights without explicit user intervention, enhancing its proactive capabilities and responsiveness.

The auto-query system typically operates through predefined rules, algorithms, or machine learning models that determine when and how queries should be generated. These rules may consider various factors such as time, user activity, system events, or external data sources to trigger the generation of queries.

Once triggered, the auto-query system formulates queries based on the identified criteria or objectives. These queries may involve retrieving data from internal databases, external APIs, or other sources of information relevant to the AI engine's tasks or applications.

After formulating the queries, the auto-query system submits them to the AI engine for processing. The engine then executes the queries, performs the necessary analyses or computations, and generates outputs or responses based on the obtained results.

The auto-query system continuously monitors the environment for new triggers or updates, adjusting its query generation process dynamically to adapt to changing conditions or requirements. This iterative cycle of query generation, execution, and response enables the AI engine to autonomously gather and process information, providing timely insights and actions without direct user intervention.

### Advanced Algorithmic Framework:

Technical Details: The core of the Semantic Embedding Searches is an advanced algorithmic framework, primarily based on cutting-edge machine learning models like deep neural networks (DNNs) and natural language processing (NLP) algorithms. These algorithms are intricately designed for deep semantic analysis, allowing them to understand language nuances, idiomatic expressions, and context. The framework utilizes vast and diverse datasets, encompassing different languages, dialects, and jargon, to train the models in recognizing and interpreting the subtleties of human language.

To implement an advanced algorithmic framework for an AI engine, particularly focusing on Semantic Embedding Searches, the process begins with selecting state-of-the-art machine learning models, such as deep neural networks (DNNs) and natural language processing (NLP) algorithms. These models are intricately designed to conduct deep semantic analysis, capable of discerning language nuances, idiomatic expressions, and contextual cues. The framework is meticulously crafted to utilize vast and diverse datasets, encompassing various languages, dialects, and jargon, to train the models comprehensively in recognizing and interpreting the subtleties of human language. Following data gathering, preprocessing ensures the data is refined and standardized for training. Through extensive model training with advanced techniques like transfer learning and hyperparameter tuning, the algorithms are optimized for semantic embedding searches. Evaluation and validation procedures confirm the effectiveness of the trained models, assessing their ability to capture semantic similarities accurately. Finally, the trained machine learning models are seamlessly integrated into the AI engine's architecture, enabling it to perform semantic embedding searches effectively, thereby enhancing its capacity to understand and respond to user queries with precision and relevance.

Applications: This sophisticated framework finds its application in a range of scenarios, from customer service bots providing contextually relevant answers to complex academic research queries in digital libraries. It can adapt to different fields by understanding the specific linguistic nuances of each domain, be it legal terminology, medical jargon, or technical language in engineering documents.

The sophisticated algorithmic framework boasts a broad spectrum of applications, catering to diverse scenarios and fields. One such application lies in customer service, where the framework powers intelligent chatbots capable of delivering contextually relevant responses to customer inquiries, thereby enhancing user experiences. Additionally, within digital libraries and academic research platforms, the framework facilitates advanced search and recommendation systems, enabling users to explore scholarly content efficiently by understanding complex queries and academic nuances. Moreover, in legal contexts, the framework aids in analyzing legal documentation and contracts by interpreting legal terminology and extracting crucial information for legal professionals. Similarly, within healthcare, it assists in medical diagnosis and patient care by interpreting medical jargon and diagnostic reports, thereby improving decision-making processes for healthcare professionals. Lastly, in engineering and technical domains, the framework aids in analyzing technical documentation, manuals, and specifications, empowering engineers to extract relevant information for various tasks such as product design and quality control. Overall, the advanced algorithmic framework's adaptability to different fields and its understanding of specific linguistic nuances make it invaluable in enhancing productivity, decision-making, and user experiences across industries.

Development Process: The development of this framework is an iterative process. It involves continuous training with large text corpora, encompassing literature from various fields. The system also incorporates feedback loops, where user interactions are used to refine and adjust the models, ensuring that the system is not only learning but also evolving with each interaction.

Contextual and Linguistic Analysis:

Technical Details: A critical component of Semantic Embedding Searches is the integration of contextual information and linguistic theory. The system uses a combination of sentiment analysis, syntactic parsing, and semantic understanding to interpret queries accurately. Contextual data may include user history, the current environmental setting, and other relevant external factors, helping the AI discern the intention behind a query.

Applications: This feature is particularly useful in environments where the context significantly alters the meaning of a query. For instance, in legal or medical advisory systems, understanding the subtlety of a query could mean the difference between a general response and a life-saving piece of advice.

Innovation: This system sets a new benchmark in AI interaction by not just understanding the literal meaning of words but by grasping the essence of user queries. It marks a significant leap from traditional keyword-based search algorithms to a more nuanced, understanding-based approach.

### Real-Time Language Model Updates:

Technical Details: In the fast-evolving world of linguistics, the Semantic Embedding Searches system stands out with its capability to update its language models in real-time. It could employ techniques such as online machine learning or continuous adaptation, where the system integrates new linguistic developments, user-specific jargon, and evolving language trends as they happen.

Applications: This feature is essential in dynamic sectors like finance, technology, or pop culture, where new terms and usages emerge rapidly. The system's ability to adapt in real time ensures that it remains relevant and accurate in its responses, irrespective of how quickly the linguistic landscape changes.

Challenges and Solutions: One of the main challenges in real-time model updates is maintaining a balance between the system's stability and its adaptability. The system addresses this by employing robust algorithms that filter and validate new linguistic data before integration, ensuring that the core model remains reliable while still evolving. Contextual Query Interpretation:

Deep Contextual Insights: The system doesn't just interpret queries in isolation. It draws upon a rich tapestry of contextual information, including historical user interactions, current global events, and domain-specific knowledge, to fully grasp the query's context.

Emotional and Cultural Intelligence: Going beyond traditional data, the AI incorporates emotional and cultural intelligence in its analysis, enabling it to understand and respond to queries with an awareness of the user's emotional state and cultural background.

Predictive Contextual Modeling: Leveraging predictive analytics, the system can foresee the context of future queries based on past patterns, positioning it to provide more relevant and proactive responses.

### Adaptive Response Mechanism:

Dynamic Relevance Scoring: The AI employs a dynamic scoring system to evaluate the relevance of the top N results from semantic searches. This scoring system adapts based on the user's immediate feedback and long-term interaction patterns.

Customizable Response Strategies: Users have the ability to customize how the AI formulates responses, choosing from a range of strategies that prioritize different aspects such as detail level, brevity, or technical complexity.

Interactive Response Refinement: The system offers users the option to refine AI responses interactively. Users can request clarifications, additional information, or alternative explanations, which the AI uses to fine-tune its response mechanism.

User-Guided Deep Exploration:

Technical Details: This feature enables users to steer the direction of the AI's research and information retrieval process. It is powered by a sophisticated system that allows for detailed, user-directed queries. The AI employs advanced search algorithms and data retrieval techniques to delve into specialized databases and external knowledge sources, based on the user's specific instructions. This could involve natural language understanding to interpret user commands and transform them into complex search queries.

Application Scenarios: User-Guided Deep Exploration is especially valuable in research-intensive fields such as academic research, market analysis, and technical troubleshooting. Here, users can leverage the AI's capabilities to conduct in-depth investigations on specific topics, drawing on a wealth of information beyond standard search results.

Integration with External Databases: This system is designed to tap into a variety of external databases and resources, ranging from academic journals and industry reports to multimedia content repositories. The AI navigates these sources, effectively synthesizing and presenting information in a coherent and user-friendly format.

### Collaborative Query Expansion:

Interactive Process: In Collaborative Query Expansion, the user and the AI engage in a real-time, dialogue-based interaction. This feature allows users to refine and expand their queries through an iterative conversation with the AI. The system is equipped with advanced dialogue management capabilities, enabling it to understand, respond to, and even anticipate the user's informational needs during the interaction.

Technical Backbone: The foundation of this feature lies in real-time data processing and sophisticated language understanding algorithms. These algorithms are designed to process user input, understand the context, and dynamically adjust the direction of the query based on the conversation's flow.

Use Case Examples: This feature is particularly beneficial in situations requiring collaborative brainstorming or when tackling complex problems that require iterative refinement of queries. Users can engage with the AI to explore different facets of a topic, leading to more comprehensive and well-rounded answers.

### Continuous Learning Loop:

Sophisticated Feedback Analysis: Each interaction within the Manual Query Enhancement feature contributes to the system's learning process. The AI analyzes feedback, both explicit (like user ratings) and implicit (such as the time spent on certain responses or linguistic cues indicating satisfaction or confusion). This feedback analysis uses machine learning algorithms to continually refine the system's understanding and improve response accuracy.

Adaptive Knowledge Evolution: The knowledge base of the AI is dynamic and evolves with each user interaction. As users guide the AI through different queries and provide feedback, the system assimilates new information, enriching its database. This ensures that the AI's responses are up-to-date and increasingly tailored to individual user needs and preferences.

User Engagement: The system tracks user engagement metrics to further enhance its performance. By analyzing how users interact with the AI (like the types of queries asked, the depth of exploration, and the frequency of interactions), the AI fine-tunes its query handling and information retrieval processes.

### Customizable Knowledge Base:

This aspect of the invention allows for unprecedented personalization and adaptability in AI knowledge:

### User-Defined Data Integration:

Technical Details: This component allows users to import their own datasets into the AI system, effectively customizing the knowledge base. The system is equipped to handle a wide variety of data types-from textual documents, spreadsheets, PDFs to more complex formats like images, audio files, and videos. It utilizes advanced data parsing and integration algorithms to seamlessly merge external data with its existing knowledge base.

User Empowerment: This feature is particularly beneficial for users needing specialized knowledge bases, such as researchers, industry experts, or businesses. For instance, a medical researcher could upload the latest clinical trial data, or a market analyst might integrate real-time market feeds.

Data Processing Capabilities: The system includes capabilities like data cleansing, normalization, and categorization to ensure that user-uploaded data is efficiently and accurately integrated into the AI's knowledge base.

### Dynamic Knowledge Update Mechanism:

Real-Time Updates: The AI system features a dynamic knowledge update mechanism that continuously assimilates new information. This includes updates from external sources like news feeds, academic journals, and industry reports, ensuring the AI stays abreast of the latest developments in various fields.

Adaptive Learning: The system is designed to recognize and prioritize new information, adjusting its responses and recommendations based on the most current data. This feature is crucial in fast-evolving domains like technology, medicine, and finance, where staying updated is key to accuracy and relevance.

Update Validation: To maintain the integrity of the knowledge base, the system includes validation protocols. These protocols assess the credibility and relevance of new information before integration, ensuring that the AI's knowledge remains accurate and reliable.

Interactive Learning Interface:

User Interaction: This aspect involves a user-friendly interface that allows users to directly interact with and influence the AI's learning process. Users can specify areas of interest, pose questions, or provide feedback, which the AI uses to refine its knowledge and understanding.

Customization Tools: The interface includes tools for users to define the scope of the AI's knowledge. This might include setting parameters for the types of information the AI should prioritize, creating custom categories or topics, or even specifying particular sources the AI should focus on.

Feedback Loop: The interactive learning interface incorporates a feedback loop where the AI learns from user interactions. This includes tracking which responses users find helpful and adapting its learning focus accordingly.

### Personalization Algorithms:

Algorithm Design: The AI employs advanced personalization algorithms to tailor its responses to individual user preferences and needs. These algorithms analyze user interactions, learning from each query, response choice, and feedback to build a personalized understanding of each user.

Historical Interaction Analysis: The system analyzes historical interactions to identify patterns in user preferences, such as favored topics, desired depth of information, and preferred data sources. This historical analysis allows the AI to anticipate user needs more accurately.

Customization and Adaptability: These personalization algorithms are designed to evolve with the user. As a user's needs and preferences change over time, the AI adapts, ensuring that its responses remain relevant and personalized. This is particularly beneficial in long-term user interactions, as it allows the AI to grow and evolve alongside the user.

### Multi-Modal Vector Database:

The multi-modal vector database is a technological marvel, offering extensive functionality and versatility:

### Advanced Data Storage Solutions:

Technological Foundations: The database is equipped with state-of-the-art data compression and storage techniques, designed to handle and process large-scale, heterogeneous data. This involves using advanced algorithms for efficient data encoding and compression, minimizing storage space while maintaining data integrity.

Security Measures: Given the diverse nature of the data, security is paramount. The database employs robust encryption methods and secure data transmission protocols to protect data integrity and confidentiality. This includes implementing the latest standards in cybersecurity to safeguard against unauthorized access and data breaches.

Efficiency and Accessibility: Despite the vast amounts of data, the system is optimized for high-speed data retrieval and processing. This ensures that users can access and analyze data quickly and efficiently, a crucial aspect in time-sensitive applications.

### Intelligent Metadata Processing:

Contextual Understanding: The database utilizes sophisticated metadata processing algorithms to understand the context and relevance of the stored data. This involves analyzing data descriptors and tags to categorize and index data efficiently.

Enhanced Data Retrieval: By understanding metadata, the AI can perform more accurate and contextually relevant searches. This capability is crucial in providing precise and relevant responses to complex queries, as it allows the system to quickly identify and retrieve the most pertinent data.

Application in Diverse Fields: This feature is particularly beneficial in fields like healthcare, where understanding the context of medical data (like patient history) is as important as the data itself, or in legal research, where the relevance and context of case files and precedents are crucial.

### Seamless Data Integration:

Multi-Format Compatibility: The database is designed to integrate data across multiple formats seamlessly. This includes textual data (such as documents and emails), visual data (like images and videos), and auditory data (such as audio recordings and voice memos).

Unified Data Model: The system employs a unified data model that allows for the integration of these diverse data types into a coherent structure. This ensures that the AI can access and analyze different data types simultaneously, providing a comprehensive multi-modal experience.

User Experience: This feature enables users to interact with the AI system in a more natural and intuitive way, as they can input queries in various formats, be it typing a question, uploading an image, or recording a voice memo.

### Scalable and Flexible Architecture:

Scalability: The architecture of the database is designed to be highly scalable, capable of accommodating an ever-expanding range of data types and volumes. This scalability ensures that the system can grow and adapt to increasing data demands without compromising performance.

Flexibility in Application: The flexible nature of the architecture allows it to adapt to evolving user needs and technological advancements. Whether it's integrating new data types emerging from novel technologies or expanding capacity to handle growing data volumes, the system is built to adapt and evolve.

Future-Proofing: The architecture is designed with future technological developments in mind. This includes the ability to integrate with emerging data formats and to adapt to new methods of data processing and analysis, ensuring that the system remains at the forefront of technological innovation.

### Quantum-Resistant Key Encapsulation Mechanism (KEM):

Implementation of Kyber Crystal Suite: The database incorporates the Kyber Crystal Suite, a quantum-resistant key encapsulation mechanism. This advanced cryptographic protocol is designed to securely encapsulate and transmit encryption keys even in the presence of quantum computing threats. It ensures that data, such as movies or songs, can only be accessed by authorized users, effectively safeguarding against unauthorized sharing or piracy.

Technical Advantage: The use of Kyber provides strong security assurances, as it is based on hard mathematical problems that remain intractable even for quantum computers. This makes the encryption method highly resilient to both current and future cryptographic attacks.

### Quantum-Resistant Digital Authentication:

Dilithium Digital Signatures: Alongside key encapsulation, the system employs Dilithium, a quantum-resistant algorithm for digital signatures. This ensures the authenticity and integrity of the data. When a user downloads content like a movie or a song, the Dilithium digital signature verifies that the content is genuine and has not been tampered with.

Enhanced Security Protocols: The combination of Dilithium digital signatures with Kyber Crystal Suite encryption provides a dual layer of security. This not only protects the data itself but also ensures that the digital keys used to access the data are authentic and have not been compromised.

### Secure Download and Decryption Process:

User-Specific Quantum Encrypted Keys: Each authorized user receives a unique, quantum-encrypted key, which is necessary to decrypt and access the content. This key is generated and encapsulated using the Kyber Crystal Suite, ensuring its security during transmission.

Prevention of Unauthorized Sharing: The quantum-encrypted key is tied to the user's device and account, making it virtually impossible to replicate or share. This ensures that purchased or accessed content cannot be illegally distributed or accessed on unauthorized devices.

Continuous Security Updates: Recognizing the rapid advancements in quantum computing, the system is designed to continuously update and adapt its cryptographic algorithms. This ensures that the database remains secure against emerging quantum threats, safeguarding the content and the keys well into the future.

### 5.4 Advanced Video Processing:

This innovative component introduces a novel approach to video content analysis:

### Frame Collaging Technique:

Conceptual Framework: The frame collaging technique is a method where multiple frames from a video are composited into a single collage image. This technique enables the system to analyze several frames concurrently to detect patterns, movement, and changes over time that may not be apparent when viewing frames in isolation.

Detailed Analysis: By examining a collage of frames, the system can perform a more nuanced analysis of the video content, such as tracking the trajectory of moving objects, observing changes in facial expressions, or detecting subtle shifts in the environment.

Application in Complex Scenarios: This method is particularly effective for complex video analysis scenarios like sports analytics, where it can be used to understand the dynamics of player movements, or in security footage review, to identify suspicious behaviors over a sequence of events.

### Multi-Threading for Efficiency:

Technical Implementation: Multi-threading is employed to enhance the efficiency of video processing. The system can divide the task of analyzing video content across multiple processor threads, allowing for parallel processing of different video segments.

Speed and Performance: This approach significantly reduces the time required to process video by leveraging the capabilities of modern multi-core processors. It ensures that large volumes of video can be analyzed much faster than sequential processing methods.

Real-World Applications: In practical applications such as video editing software or traffic management systems, multi-threading enables the system to handle high-resolution videos or multiple video streams without a loss in performance.

### Audio-Visual Synchronization:

Holistic Interpretation: Audio-visual synchronization is a process where the system aligns audio transcription with the corresponding video frames. This provides a comprehensive interpretation of the video content, as both visual cues and auditory information are considered together.

Contextual Relevance: By synchronizing audio and visual data, the system can provide contextually relevant analysis, such as matching spoken words with lip movements or correlating sounds with visual events.

Enhanced Content Analysis: This feature is vital in applications like automated subtitle generation, where accurate timing between audio and visual elements is crucial, or in multimedia learning environments, to enhance the educational experience.

### Real-Time Processing Capability:

Versatility in Processing: The system is equipped to handle both pre-recorded video and live video streams. This real-time processing capability allows it to be applied in a variety of settings, from on-demand video analysis to real-time event monitoring.

Immediate Insights: With real-time processing, the system can provide immediate insights, which is essential in scenarios such as live broadcasts, where instant analysis is required, or in traffic monitoring systems, where real-time data can inform immediate decisions.

Advanced Content Interpretation Algorithms:

Algorithmic Complexity: The system uses complex algorithms to interpret video content. These algorithms incorporate machine learning and computer vision techniques to identify and understand key elements within the video, such as character recognition, action detection, and context understanding.

Intelligent Interpretation: The algorithms are capable of recognizing and learning from a variety of visual patterns, enabling the system to improve its accuracy over time as it is exposed to more video content.

Diverse Applications: Such algorithms are crucial in applications like autonomous driving systems, where understanding the environment is key to safe navigation, or in content recommendation engines, to identify genres and preferences based on visual cues.

### 5.5 Universal Device Compatibility:

One of the most significant aspects of this invention is its universal compatibility, ensuring broad applicability and accessibility:

Cross-Platform Functionality: The system is designed to operate across a diverse range of devices and platforms, from mobile devices and tablets to desktop computers and IoT devices.

Adaptive Interface Design: The user interface adapts to the specific capabilities and limitations of each device, ensuring optimal functionality and user experience.

Resource Management Mechanisms: Advanced resource management algorithms ensure efficient operation, optimizing performance according to the device's processing power and memory capabilities.

Integration with Existing Ecosystems: The architecture is designed to integrate seamlessly with existing software and hardware ecosystems, enhancing the utility of the devices without necessitating significant modifications.

Figures

6.1 FIG. 1

FIG. 1 depicts the comprehensive architecture 100 of an advanced virtual architecture application 101, detailing the interaction between the user 103, the local device 105, and the cloud-based repositories (e.g., model repository 107 and dataset repository 109):

Model Repository 107: A cloud-based repository that users may download models and datasets from. This can be third party websites like hugging face, github, etc.

May contain multiple servers that store a variety of AI model files.

Open models are specialized for different functions, such as text, image, video, code, and voice generation. The system is designed to work with any Large X Model that users want to use.

Dataset Repository 109: Hosts embedded files on the server (Local Device) that are pre-processed and ready for use by the AI models.

Includes packaged data that can be quickly accessed and utilized by the system.

Features a lattice-based storage system specifically for managing data embeddings efficiently.

### Model Download Gate 111:

Serves as a security checkpoint that authenticates the AI models before they are downloaded onto the local device.

Local Device 105: This can be a laptop, desktop, mobile phone, IOT device, or any electronic with hardware capabilities and operating systems required to run AI models.

Receives various AI models from the cloud repositories via websites/automated functions inside of the Application.

Downloads models are specific to the user's needs, such as text generation or image creation.

Advanced Virtual Architecture Application 101: The Application or system is run locally, with the ability to connect to the internet and download models and datasets, but is capable of running models and downloads offline without needing external servers (if the device is capable of running the minimum requirements for the models chosen).

Provides AI settings for users to select and customize the AI model for their queries.

Includes a user interface (User UI) for input and interaction with the AI.

Contains a Vector Database UI for structured data retrieval.

Offers tuning options for personalizing AI response and performance.

Dataset Downloads from Repository 113 and Uploads from File System 115: Allows users to download topic-specific embedded data for use by the AI.

Enables users to upload their datasets into the system for embedding and future retrieval.

User Interaction and Output Generation: Users interact with the system via voice, text, video, or other forms of input.

The system generates outputs such as voice, video, text, or files, based on the input and selected models.

User: The end-user directly interacts with the local device and the advanced virtual architecture app.

They provide input, receive outputs, and have the ability to customize the settings and parameters of the AI models.

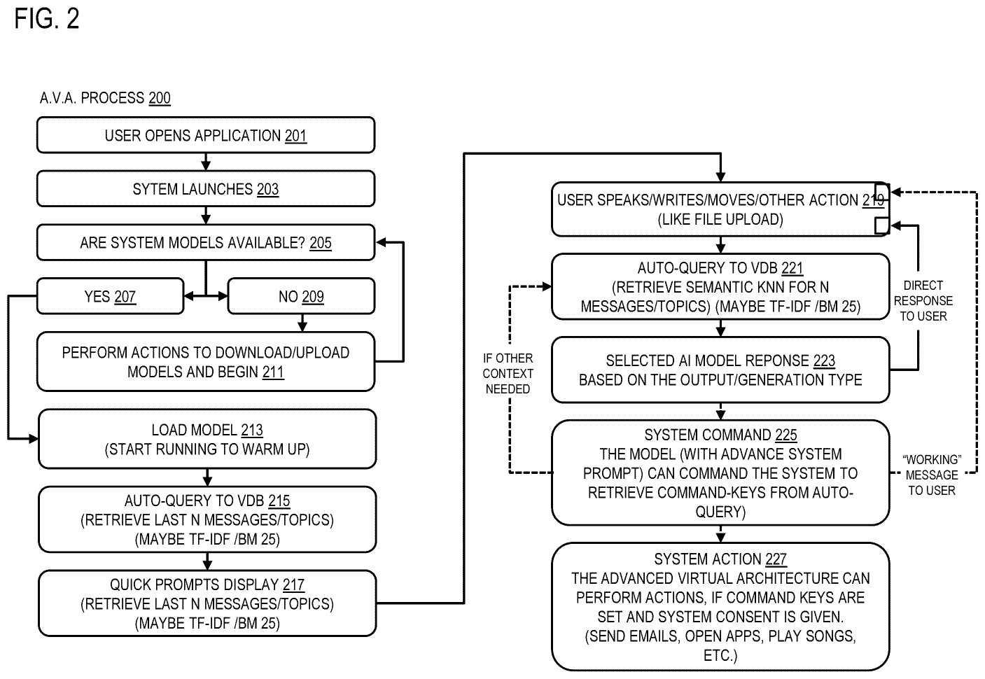

6.2 FIG. 2

FIG. 2 outlines the process flow 200 of the Advanced Virtual Assistant (A.V.A.) application 101, detailing the steps from application launch to task execution:

### User Interaction Initiation 201:

The user starts the interaction by opening the application.

### System Launch Sequence 203:

Upon user initiation, the system begins its launch process.

### Model Availability Check 205:

The system checks if the necessary AI models are available for use (process 207).

The system checks if the necessary AI models are available for use (process

If models are not available (process 209), it performs actions to download or upload the required models (process 211).

### Model Preparation:

Once models are available, the system loads the selected model to ‘warm up,’ preparing it for prompt responses (process 213).

### Automatic Query to Vector Database (VDB) 215:

The system auto-queries the Vector Database to retrieve the last ‘N’ messages or topics that might be relevant to the user.

It may employ TF-IDF or BM25 algorithms to enhance the relevance of retrieved data.

### Display of Quick Prompts 217:

The user interface displays quick prompts based on recent searches or topics to the user.

The user has the option to start a new conversation from ‘scratch’ or choose from the displayed prompts.

### User Input Processing:

The user provides input via speech, writing, movement, or other actions such as file uploads (process 219).

### Contextual Data Retrieval 221:

If additional context is needed, the system auto-queries the VDB again.

It retrieves semantic K-Nearest Neighbors (KNN) for ‘N’ messages or topics, potentially utilizing TF-IDF or BM25 to rank the relevance of this information.

### AI Model Response Selection 223:

Based on the user's input and the retrieved context, the system selects the appropriate AI model to generate a response.

### System Command Execution 225:

The selected AI model, equipped with an advanced system prompt, issues commands to the system to retrieve command-keys from the auto-query results.

A “Working” message may be displayed to inform the user that the system is processing their request.

### Completion of System Actions 227:

The Advanced Virtual Architecture carries out actions as directed by the command keys, such as sending emails, opening applications, playing songs, etc., assuming the system has the user's consent to perform these actions.

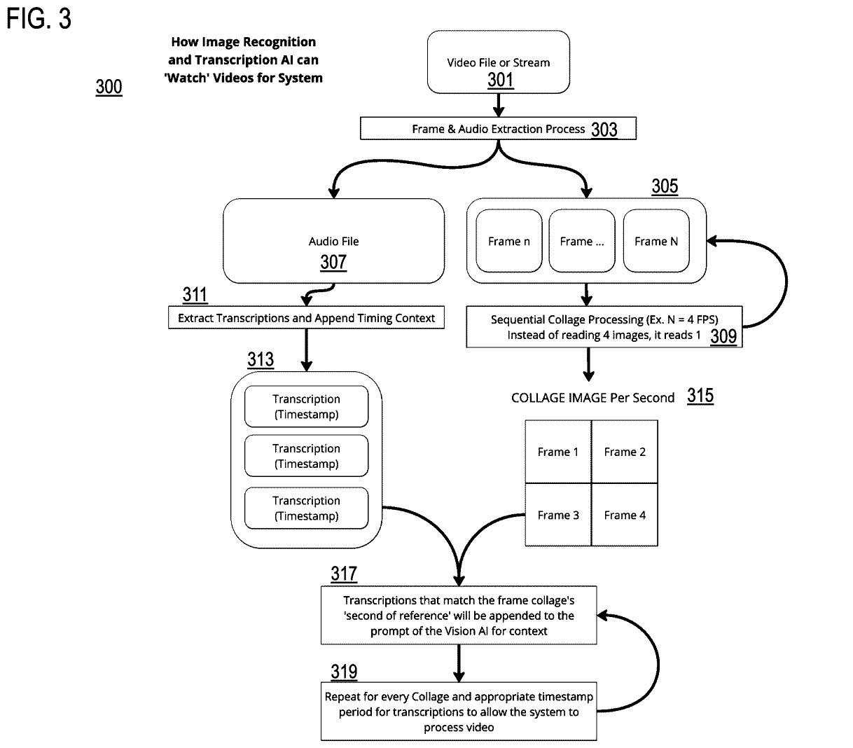

6.3 FIG. 3

FIG. 3 illustrates the workflow 300 of an advanced video processing system designed to enhance the analysis and comprehension of video content through a novel frame collaging technique and synchronized audio transcription. The process flow 300 is depicted in a series of operational blocks that define the system's functionality:

Video File or Stream Input 301: The system accepts a video file or stream as its input, which is the primary source material for subsequent processing.

Frame and Audio Extraction Process 303: Upon input, the system separates the video into two primary components: the visual frames (Frame n to Frame N) 305 and the accompanying audio track (Audio File) 307. This separation is critical for individual processing of audio and visual data.

Sequential Collage Processing 309: The visual data is processed using a ‘frame collaging’ technique, wherein a predefined number of sequential frames (e.g., four frames per second) are composited into a single collage image. This collage represents a condensed visual summary of the video content over the specified time interval, thereby reducing the number of images the system needs to analyze without losing temporal context.

Extraction of Transcriptions with Timing Context 311: Concurrently, the audio file is transcribed, and timing context is added to each transcription. This process timestamps the transcription 313, allowing for synchronization with the video frames.

Collage Image Per Second 315: The frame collage is structured to display multiple frames for each second of video content, enabling simultaneous analysis of these frames as a single image. This approach allows the system to identify patterns or changes that occur within this second, which might be missed if frames were analyzed independently.

Synchronization of Transcription and Collage Image 317: Each transcription is then matched with the corresponding frame collage based on the ‘second of reference.’ This ensures that the context provided by the audio transcription is directly related to the visual content during the same timeframe.

Context-Enhanced Vision AI Prompting: The synchronized transcriptions are appended to the vision AI's processing prompt for each collage image. This amalgamation of visual and auditory data provides enriched context, enhancing the AI's ability to analyze and interpret the content accurately.

Iterative Processing for Video Analysis 319: The system repeats this process for each subsequent collage and associated transcriptions throughout the entire duration of the video. This iterative process ensures comprehensive analysis across the video's entirety.

The described methodology allows the system to process and analyze video content with increased efficiency and enhanced context recognition, providing a significant improvement over traditional frame-by-frame video analysis methods.

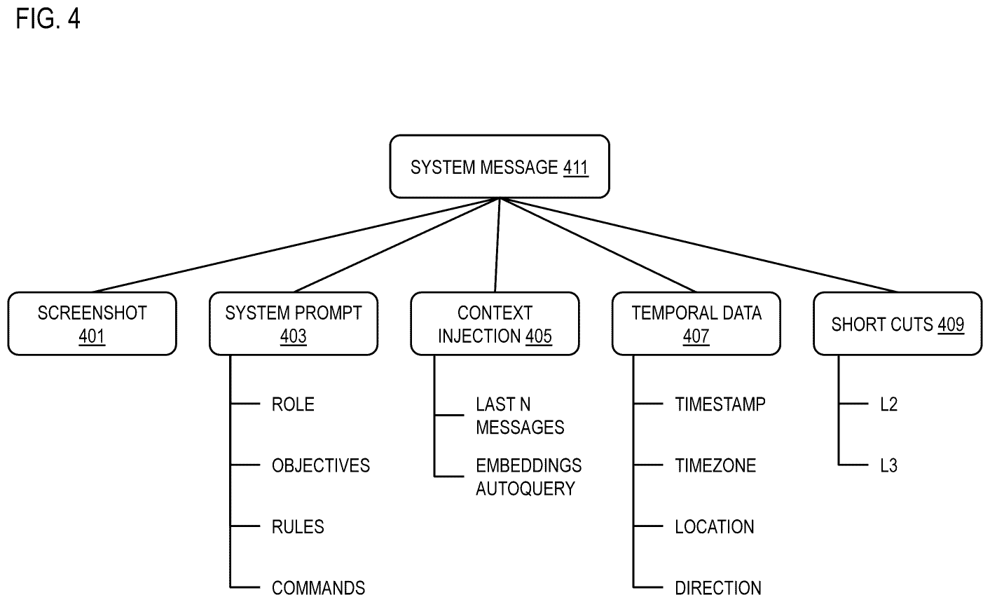

FIG. 4 is a diagram of an example system 400 for AVA, according to one embodiment. In one embodiment, the system 400 comprises multiple interrelated modules—including a Screenshot Processing Module 401, a System Prompt Module 403 (with role, objectives, rules, and commands subcomponents), a Context Injection Mechanism 405, a Temporal Data Module 407, and a Shortcuts Module 409—that together capture, analyze, and integrate real-time and historical data. The combined output is synthesized by a central integration unit (e.g., system messages module 411) to generate contextually enriched prompts for an offline AI engine, thereby enhancing response accuracy and operational efficiency without reliance on continuous network connectivity.

In one embodiment, the Screenshot Processing Module 401 is a dedicated screen capture engine periodically or on-demand captures images of the current display. Its functionality include but is not limited to:

Context Extraction: Embedded image recognition and optical character recognition (OCR) algorithms analyze these screenshots to extract active application states, interface elements, and textual content.

Metadata Annotation: Each captured image is automatically tagged with metadata—such as capture timestamp, active process identifiers, and contextual descriptors—to support downstream processing.

Filtering and Preprocessing: The module incorporates configurable filters to exclude sensitive information and to optimize images (e.g., cropping or resolution adjustment) prior to integration with other system components.

Advantages: This module ensures that visual contextual cues are available for enhancing the AI's understanding of the current user environment, thereby improving both the relevance and personalization of subsequent system responses.

In one embodiment, the System Prompt Module 403 is subdivided into four subcomponents that collectively generate the operational prompt for the AI:

Role Determination Submodule: Identifies the persona or functional role the AI should adopt during the interaction (e.g., advisor, assistant, analyst). It utilizes user profiles, historical interaction data, and situational context to select an appropriate role.

Objectives Submodule: Consolidates the user's current tasks, goals, or intents. It aggregates input from recent queries and inferred user needs to define explicit objectives for the AI's actions.

Rules Submodule: Enforces operational guidelines, behavioral constraints, and system policies. It retrieves predefined rules (including privacy constraints, usage protocols, and operational limits) from a local repository to ensure that the AI's responses remain within acceptable bounds.

Commands Submodule: Interprets direct user commands and translates them into executable system actions. It validates and maps command inputs against the system's rule set before triggering any corresponding functions.

The outputs of these submodules, for instance, are synthesized into a unified system prompt that clearly delineates the AI's role, objectives, and operational boundaries. This prompt is then passed on to the central integration unit.

In one embodiment, the Context Injection Mechanism 405 includes the following components and processes:

Historical Data Retrieval: Automatically queries a local data store or vector database for the “Last N” messages, previous interactions, and related query histories. It employs time-based and relevance-ranked queries to retrieve contextually pertinent historical data.

Semantic Embedding Search: Uses advanced machine learning models to conduct semantic similarity searches within stored embeddings. It aligns current query semantics with historical data to extract meaningful contextual correlations.

Contextual Annotation and Integration: Annotates retrieved data with metadata such as timestamps, relevance scores, and usage frequency. This annotated context is then “injected” into the system prompt, ensuring that the AI's processing includes historical continuity and contextual awareness.

By integrating historical context, this mechanism enables the system to maintain conversational continuity and adapt responses based on prior interactions, thus improving overall accuracy and user satisfaction.

In one embodiment, the Temporal Data Module 407 includes the following functional elements:

Timestamp Generator: Captures the precise time of each user interaction and system event. It automatically attaches timestamps to all data inputs, which are critical for sequencing and contextual relevance.

Timezone and Location Integration: Determines the user's current timezone and, when permitted, the geographic location. It uses device sensors and network data to adjust system behavior and output responses that are sensitive to local time and regional context.

Directional Data Processor: Analyzes temporal trends and user activity patterns (e.g., increasing or decreasing frequency of similar queries). It applies pattern recognition algorithms to infer directional trends in user behavior, which are then factored into the AI's response generation.

Incorporating temporal parameters ensures that system responses are not only current but also relevant to the user's immediate context, thereby enhancing both timeliness and accuracy.

In one embodiment, the Shortcuts Module 409 include the following functional elements:

L2 Cached Shortcuts: Represent primary shortcuts that trigger frequently used functions.

L3 Cached Shortcuts: Denote secondary, more granular commands that provide direct access to less common but still essential functionalities.

The Shortcuts Module minimizes processing delays for common tasks and streamlines user interactions, thereby improving the overall responsiveness and efficiency of the system.

In one embodiment, the Central System Message Integration Unit 411 serves as the nexus for all incoming data streams from the Screenshot Processing Module 401, System Prompt Module 403, Context Injection Mechanism 405, Temporal Data Module 407, and Shortcuts Module 409. For example, it utilizes advanced natural language processing and data fusion techniques to combine these diverse inputs into a cohesive and context-rich system prompt. It can also forward the integrated prompt to the offline AI engine, ensuring that all relevant contextual, temporal, and command data are included to generate accurate and personalized responses.

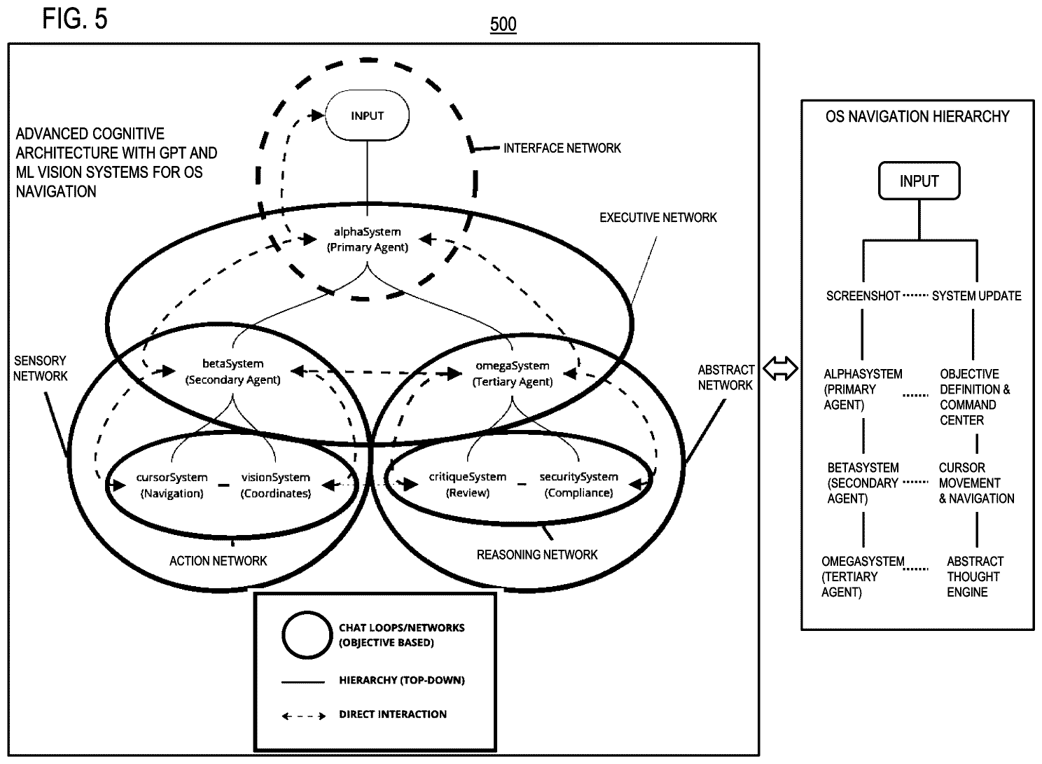

FIG. 5 is diagram of an advanced cognitive architecture 500 with GPT and ML vision systems for OS navigation, according to one embodiment. The figure presents a conceptual diagram of an Advanced Cognitive Architecture with GPT and ML Vision Systems for OS Navigation. It illustrates a hierarchical system with interconnected components designed for complex tasks, e.g., operating system navigation.

In one embodiment, the Overall Structure comprises: (1) Hierarchical (Top-Down) Control: The architecture emphasizes a top-down control flow, indicated by the dashed arrows, starting from the “INPUT” and flowing down through different levels of agents and networks; and (2) Chat Loops/Networks (Objective Based): The circles represent “Chat Loops/Networks” which are described as “objective-based.” This indicates that communication and processing within these loops are driven by specific goals or tasks.

Direct Interaction: The dashed arrows indicate direct interaction between different components, highlighting potential communication or data exchange pathways that do not necessarily follow the strict hierarchy.

In one embodiment, the components include the following: (1) Input: The starting point of the flow, representing user commands or external stimuli; (2) Interface Network: Encompasses the “INPUT” and handles initial processing and distribution of information.

In one embodiment, the Executive Network consists of three primary agents: (1) alphaSystem (Primary Agent): e.g., the central control unit, responsible for high-level decision-making and task delegation; (2) betaSystem (Secondary Agent): e.g., handles specific tasks delegated by alphaSystem; (3) omegaSystem (Tertiary Agent): e.g., focuses on specialized functions or acts as a backup/redundancy; (4) Sensory Network: e.g., processes sensory information from the environment (e.g., including cursorSystem (Navigation) to manages cursor movement and navigation within the OS; and visionSystem (Coordinates) to Process visual input, using Machine Learning (ML) for object recognition and coordinate extraction; (5) Action Network: e.g., executes actions based on the processed information; (6) Reasoning Network: e.g., handles higher-level cognitive functions like review and compliance over results from the other components of the system (e.g., includes critiqueSystem (Review) to evaluates actions and provides feedback, such as by using GPT for natural language processing; and securitySystem (Compliance) to ensures actions comply with security and/or policy protocols and constraints; and (6) Abstract Network: e.g., a more general network that handles abstract concepts and information processing.

In one embodiment of GPT and ML Vision Integration, the system leverages GPT (Generative Pre-trained Transformer) for natural language understanding and generation, for interpreting user commands and providing feedback. ML Vision Systems are incorporated for processing visual information, enabling the system to “see” and understand the OS environment. In one embodiment, the system is a Multi-Agent System. For example, the illustration of alpha, beta, and omega agents indicates a multi-agent approach, allowing for distributed processing and specialization of tasks.

By way of example, this architecture could be applied to various tasks, including but not limited to: (1) Automated OS Navigation: Allowing users to control the OS using natural language commands or visual cues; (2) Accessibility: Assisting users with disabilities in interacting with the OS; (3) Robotics: Enabling robots to navigate and interact with digital/OS environments.

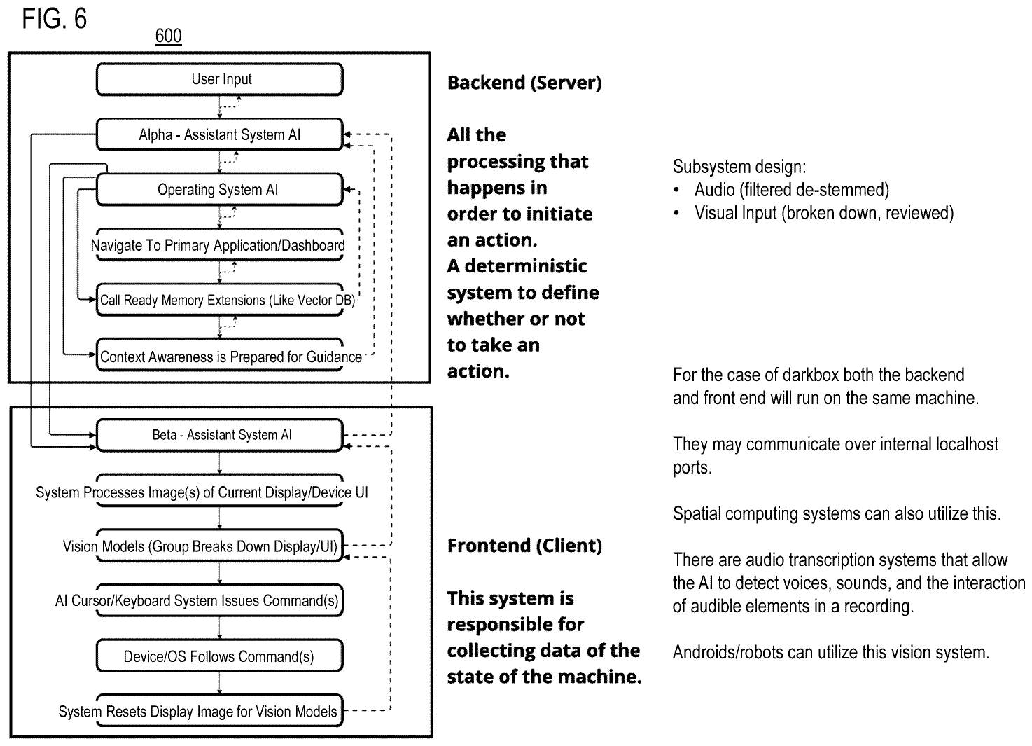

FIG. 6 is a diagram of a backend and frontend architecture 600 for AVA, according to one embodiment. This figure illustrates a system architecture designed for initiating actions (e.g., OS navigation as discussed with respect to FIG. 5 or other equivalent task) based on user input and system state, applicable to various environments including traditional operating systems, spatial computing, and robotics. The system is divided into two primary components: a Backend (Server) and a Frontend (Client). The Backend, the central processing unit, receives USER INPUT, which can be voice commands, text, or sensor data. The ALPHA ASSISTANT SYSTEM AI interprets this input, utilizing the OPERATING SYSTEM AI to interact with the underlying operating system. This interaction might involve navigating to applications, accessing memory extensions, or preparing context awareness for guidance.

In one embodiment, a secondary processing unit, the BETA OBJECTIVE SYSTEM AI, handles specific tasks delegated by the ALPHA system. The Backend's core function is to process the input and determine whether to initiate an action, employing a deterministic system for this decision. Subsystem design within the Backend includes processing audio input (filtering and de-stemming) and visual input (breaking down and reviewing). In some cases, the Backend and Frontend reside on the same machine, communicating via internal ports, or can be implemented as separate components, servers, etc.

The Frontend is responsible for collecting data about the state of the machine. It captures and processes images of the current display or device UI using the SYSTEM PROCESSES IMAGE(S) . . . UI component. VISION MODELS analyze these images, breaking down the display into its elements. The AI CURSOR/KEYBOARD SYSTEM then issues commands based on the visual information and user input, simulating cursor movements or keyboard inputs, which the DEVICE/OS then follows. The Frontend continuously captures and processes the updated display image, resetting it for the vision models, maintaining system awareness. The system also includes audio transcription capabilities, enabling the AI to detect voices, sounds, and other audible elements. This vision system is also applicable to Androids and robots. The Backend handles all the processing required to initiate an action, utilizing a deterministic system to decide whether or not to take that action.

By way of example, the components and circuitry described herein communicate with each other and other components of the communication network using well known, new or still developing protocols. In this context, a protocol includes a set of rules defining how the network nodes within the communication network interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application headers (layer 5, layer 6 and layer 7) as defined by the OSI Reference Model.

The processes described herein for providing an advanced virtual architecture for a local multi-modal AI engine may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular device, other network device, and/or other computing device.

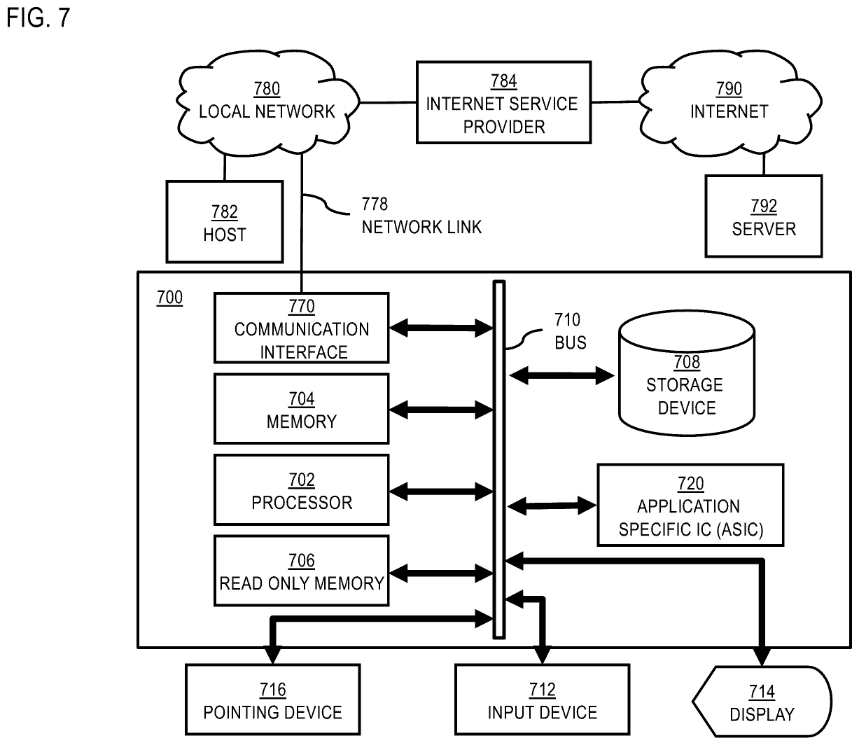

FIG. 7 illustrates a computer system 700 upon which an embodiment of the invention may be implemented. Computer system 700 is programmed (e.g., via computer program code or instructions) to provide an advanced virtual architecture for a local multi-modal AI engine as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 710 includes one or more parallel conductors of information so that information is transferred quickly among devices coupled to the bus 710. One or more processors 702 for processing information are coupled with the bus 710.

A processor 702 performs a set of operations on information as specified by computer program code related to providing an advanced virtual architecture for a local multi-modal AI engine. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or other dynamic storage device, stores information including processor instructions for providing an advanced virtual architecture for a local multi-modal AI engine. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for providing an advanced virtual architecture for a local multi-modal AI engine, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT) or a liquid crystal display (LCD), or plasma screen or printer for presenting text or images, and a pointing device 716, such as a mouse or a trackball or cursor direction keys, or motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of application specific ICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network for providing an advanced virtual architecture for a local multi-modal AI engine.

The term computer-readable medium is used herein to refer to any medium that participates in providing information to processor 702, including instructions for execution. Such a medium may take many forms, including, but not limited to, non-volatile media, volatile media and transmission media. Non-volatile media include, for example, optical or magnetic disks, such as storage device 708. Volatile media include, for example, dynamic memory 704. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system can be deployed in various configurations within other computer systems, e.g., host 782 and server 792.

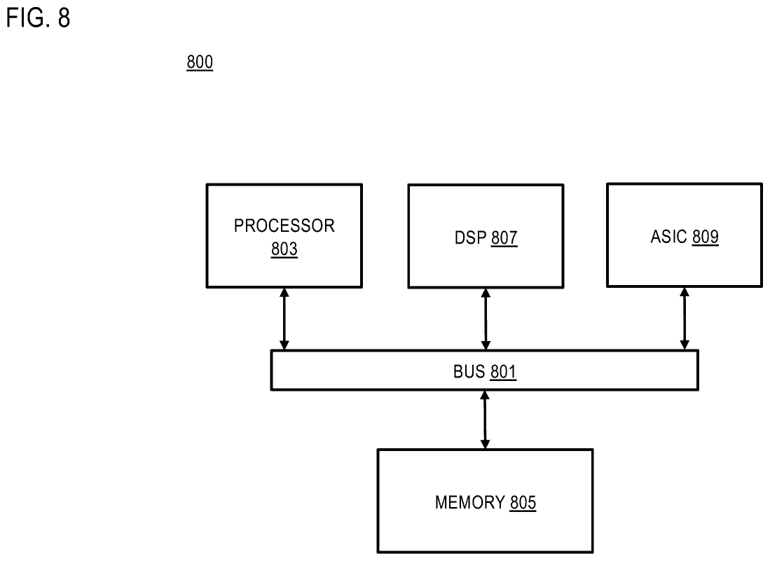

FIG. 8 illustrates a chip set 800 upon which an embodiment of the invention may be implemented. Chip set 800 is programmed to provide an advanced virtual architecture for a local multi-modal AI engine as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to provide an advanced virtual architecture for a local multi-modal AI engine. The memory 805 also stores the data associated with or generated by the execution of the inventive steps.

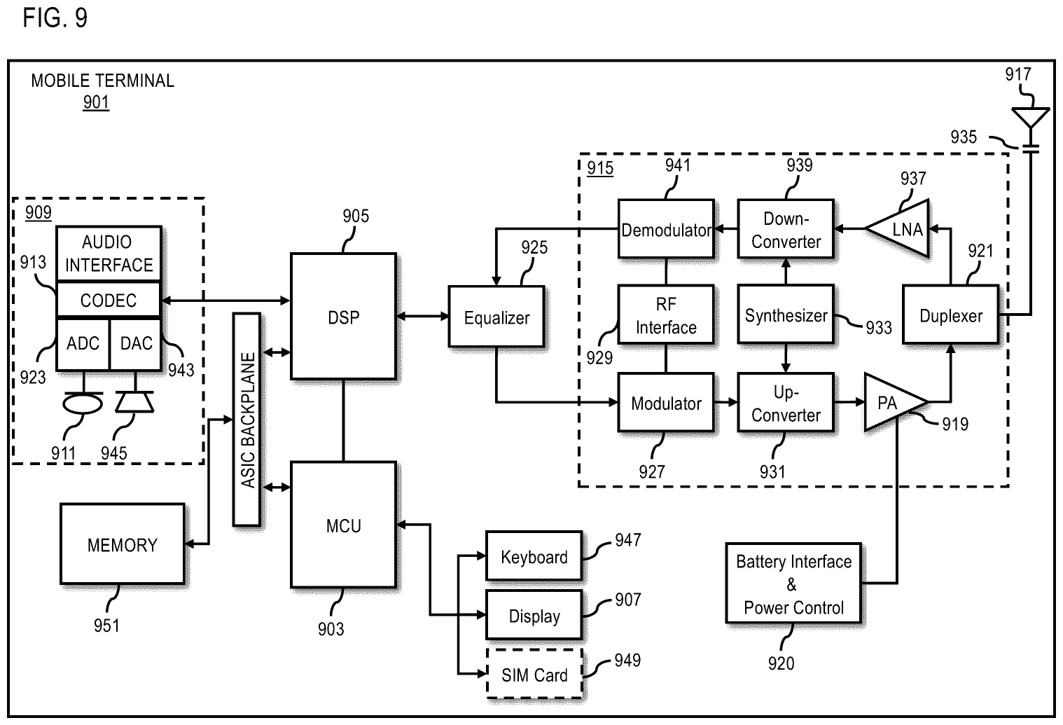

FIG. 9 is a diagram of exemplary components of a mobile terminal (e.g., handset) capable of operating in the system of FIG. 1, according to one embodiment. Generally, a radio receiver is often defined in terms of front-end and back-end characteristics. The front end of the receiver encompasses all of the Radio Frequency (RF) circuitry whereas the back end encompasses all of the base-band processing circuitry. Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile station functions that offer automatic contact matching. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile station 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (WiFi), satellite, and the like.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903-which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile station 901 to provide an advanced virtual architecture for a local multi-modal AI engine. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the station. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile station 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 951 may be, but not limited to, a single memory, CD, DVD, ROM, RAM, EEPROM, optical storage, or any other non-volatile or non-transitory storage medium capable of storing digital data.

An optionally incorporated SIM card 949 carries, for instance, important information, such as the cellular phone number, the carrier supplying service, subscription details, and security information. The SIM card 949 serves primarily to identify the mobile station 901 on a radio network. The card 949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
operating one or more artificial intelligence models for at least one task in an operating environment without internet connectivity at a device;
creating an embedded vector database comprising contextual information for the one or more artificial intelligence, wherein the embedded vector database is local to the device; and
automatically generating and engineering prompt inputs to the one or more artificial intelligence models based on the embedded vector database.

2. The method of claim 1, wherein the embedded vector database is configured to store and manage multi-modal data comprising at least two of text, images, videos, audio, or code.

3. The method of claim 1, wherein automatically generating and engineering prompt inputs further comprises utilizing contextual information derived from user interaction history and current operating environment data captured by the device, said contextual information being stored in the embedded vector database.

4. The method of claim 1, wherein the one or more artificial intelligence models are operated for a plurality of tasks selected from the group consisting of general information search, system management, professional analyses, personal file management, and multi-modal content generation.

5. The method of claim 1, further comprising continuously updating the embedded vector database with new data from local operations or user inputs, thereby enabling the one or more artificial intelligence models to adapt and refine their knowledge base over time through mechanisms including the dynamic adjustment of a lattice-space and formation of node-clusters for related embeddings within the embedded vector database.

6. The method of claim 1, wherein automatically generating and engineering prompt inputs includes performing semantic embedding searches within the embedded vector database to identify contextually relevant information, said information used to inform the responses of the one or more artificial intelligence models.

7. The method of claim 1, further comprising:
processing video content local to the device by extracting video frames and corresponding audio; creating collages of sequential video frames;
transcribing the corresponding audio to generate timed audio transcriptions;
synchronizing the timed audio transcriptions with the collages of sequential video frames; and
storing the synchronized frame collages and timed audio transcriptions as contextual information within the embedded vector database for utilization by the one or more artificial intelligence models.

8. The method of claim 7, wherein creating collages of sequential video frames comprises:
extracting frames from the video content in sequential order as they appear in the video; and
compositing a predefined number of the extracted sequential frames, or sequential frames corresponding to a specific duration of the video content, into a single collage image file, said collage image representing a condensed visual summary of a segment of the video content.

9. The method of claim 8, wherein compositing the extracted sequential frames involves blending or overlaying said frames, enabling the one or more artificial intelligence models to analyze said multiple frames concurrently as a single image to detect patterns, movement, or changes over time that may not be apparent when viewing frames in isolation.

10. An apparatus comprising:
at least one processor; and
at least one memory including computer program code for one or more programs,
the at least one memory and the computer program code configured to, with the at least one processor, cause the apparatus to:
operate one or more artificial intelligence models for at least one task in an operating environment without internet connectivity at a device;
create an embedded vector database comprising contextual information for the one or more artificial intelligence, wherein the embedded vector database is local to the device; and
automatically generate and engineer prompt inputs to the one or more artificial intelligence models based on the embedded vector database.

11. The apparatus of claim 10, wherein the embedded vector database is configured to store and manage multi-modal data comprising at least two of text, images, videos, audio, or code.

12. The apparatus of claim 10, wherein automatically generating and engineering prompt inputs further comprises utilizing contextual information derived from user interaction history and current operating environment data captured by the device, said contextual information being stored in the embedded vector database.

13. The apparatus of claim 10, wherein the one or more artificial intelligence models are operated for a plurality of tasks selected from the group consisting of general information search, system management, professional analyses, personal file management, and multi-modal content generation.

14. The apparatus of claim 10, wherein the apparatus is further caused to:
continuously update the embedded vector database with new data from local operations or user inputs, thereby enabling the one or more artificial intelligence models to adapt and refine their knowledge base over time through mechanisms including the dynamic adjustment of a lattice-space and formation of node-clusters for related embeddings within the embedded vector database.

15. The apparatus of claim 10, wherein automatically generating and engineering prompt inputs causes the apparatus to perform semantic embedding searches within the embedded vector database to identify contextually relevant information, said information used to inform the responses of the one or more artificial intelligence models.

16. A non-transitory computer-readable storage medium, carrying one or more sequences of one or more instructions which, when executed by one or more processors, cause an apparatus to at least perform the following steps:
operating one or more artificial intelligence models for at least one task in an operating environment without internet connectivity at a device;
creating an embedded vector database comprising contextual information for the one or more artificial intelligence, wherein the embedded vector database is local to the device; and
automatically generating and engineering prompt inputs to the one or more artificial intelligence models based on the embedded vector database.

17. The non-transitory computer-readable storage medium of claim 16, wherein the embedded vector database is configured to store and manage multi-modal data comprising at least two of text, images, videos, audio, or code.

18. The non-transitory computer-readable storage medium of claim 16, wherein automatically generating and engineering prompt inputs further comprises utilizing contextual information derived from user interaction history and current operating environment data captured by the device, said contextual information being stored in the embedded vector database.

19. The non-transitory computer-readable storage medium of claim 16, wherein the one or more artificial intelligence models are operated for a plurality of tasks selected from the group consisting of general information search, system management, professional analyses, personal file management, and multi-modal content generation.

20. The non-transitory computer-readable storage medium of claim 16, wherein the apparatus is caused to further perform:
continuously updating the embedded vector database with new data from local operations or user inputs, thereby enabling the one or more artificial intelligence models to adapt and refine their knowledge base over time through mechanisms including the dynamic adjustment of a lattice-space and formation of node-clusters for related embeddings within the embedded vector database.
